(19) United States
(12) Patent Application Publication
(10) Pub. No.: US 2005/0124233 A1
(43) Pub. Date: Jun. 9, 2005

(54) Contact terminal with doped coating

(76) Inventor: Tag Hammam, Sundbyberg (SE)

Correspondence Address: MORGAN & FINNEGAN, L.L.P., 3 WORLD FINANCIAL CENTER, NEW YORK, NY, 10281-2101, US

(21) Appl. No.: 10/497,837

(22) PCT Filed: Dec. 3, 2002
(86) PCT No.: PCT/FI02/00975

(30) Foreign Application Priority Data
Dec. 13, 2001 (FI) 20012453

(51) Int. Cl. H01R 9/24

(52) U.S. Cl. 439/886

(57) ABSTRACT

The invention relates to a contact terminal to be used for electrical purposes which contact terminal contains a metallic substrate with good conductivity and coated with a metallic element. In accordance with the invention the coating is doped with at least one additive in order to improve the electrical stability of the coating.

This invention relates to an electrical contact terminal having doped additives in the coating material of the coating in order to improve the functional performance and reliability.

Tin-coated copper-base alloys are commonly used in electrical contact terminals due to a low price and acceptable reliability for many applications. Tin-coated electric contacts are also used for separable contacts of plug-in-type with limited number of insertion and withdrawal cycles, for instance printed circuit board contacts and pin-socket contacts.

The main deterioration mechanism for tin-coated contact terminals are fretting caused by mechanical vibration or thermal induced movement. Fretting causes continuous oxidation of the contact area and subsequently reduction of the available conducting area with an increase of the contact resistance as a consequence. When almost all of the contact area is covered by oxide it will result in a steep increase of the contact resistance, and in practice, failure will occur. Increased contact load is well known to increase the electrical stability and extend the time to failure. However, it will result in a more expensive mechanical design, and also require an increased insertion force.

The objective of the invention is to improve the performance of tin-coated contact terminals by reducing the negative effects of fretting associated with the prior art. The essential features of the present invention are enlisted in the appended claims.

In accordance with the present invention an electrical contact terminal has a substrate made of a metal having good conductivity and the substrate is coated with a coating layer containing at least one doped additive. Using the coating material with the doped additive the electric stability of the coating layer is improved. In the preferred embodiment of the invention the substrate is made of copper or copper based alloy, the coating layer is made of tin and the doped additive is phosphorous. The amount of phosphorus is in the range of 0,05 to 2,0 atomic %, advantageously 0,1 to 0,25 atomic % phosphorus.

The idea of the preferred embodiment of the invention is that a limited amount of phosphorus in the tin will act in three steps. Altogether these steps will significantly improve the electrical stability, whilst a low contact load can be maintained. The three steps are the following:

1. The phosphorus will limit the formation of tin-oxide at the interface of two sliding surfaces, due to its de-oxidizing properties.

2. The formed tin-phosphorus oxide is more brittle and is easier to wipe off than pure tin oxide. Hence, a significant lower contact load is needed to achieve an oxide free contact spot.

3. The initial formed tin-oxide between two surfaces is made conductive by the phosphorus dope additive.

In one another embodiment of the invention the doped additive is a combination of at least two of the group antimony, zinc and cobalt. The doped additive can also be at least one of the elements copper, bismuth, silver, zinc, cobalt and antimony or a combination of these elements. Further, in one embodiment of the invention the substrate in the contact terminal is made of aluminium or aluminium based alloy.

The invention is described in more details referring to the following drawings wherein

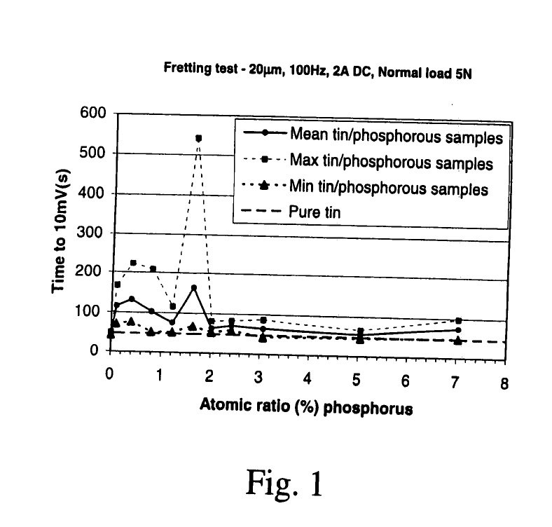

FIG. 1 illustrates the results of fretting tests using phosphorus as an additive for the time to reach a contact voltage drop of 10 mV with a normal load of 5 N,

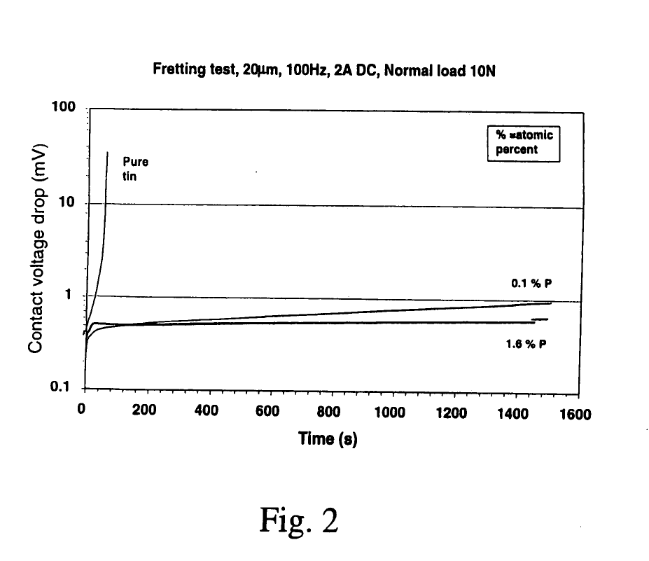

FIG. 2 illustrates the results of fretting tests using phosphorus as an additive for the contact voltage drop as function of the time.

The present invention using phosphorus as a doped additive in the tin coating was tested in a test bench for fretting tests. The said test bench consists of an electronic controlled shaker and a measurement system. Before the fretting tests all contacts were subjected to one long sliding stroke to wipe off the initial surface layer. During the fretting tests, the contacts were subjected to a current load of 2 A DC, and mechanical oscillations of a frequency of 100 Hz with an amplitude of 20 micrometer. Normal loads of 5 N and 10N were applied. The tests were interrupted just after the contact voltage had passed 70 mV.

Besides pure tin ten different tin phosphorus alloys were produced by casting rods. Before the fretting tests all samples were turned to achieve a fresh surface. The contact voltage usually increased slowly from a low level to a point when the increase starts to accelerate and finally rises steeply above the softening and melting voltage of tin, resulting in an unstable electrical contact.

In order to evaluate the effect of phosphorus for the electrical stability during fretting the results of the fretting tests were evaluated on the basis of the following aspects:

1) The times to reach a contact voltage drop of 10 mV at a contact load of 5 N.

2) Contact voltage after 1500 seconds (150.000 fretting cycles) at a contact load of 10 N.

FIG. 1 illustrates the time to reach a contact voltage drop of 10 mV with a normal load of 5 N. Based on the FIG. 1 tin with 0.1 up to 2 atomic % of phosphorus achieved in general a significant increased time to instability compared with the pure tin samples.

FIG. 2 illustrates the contact voltage drop as a function of testing time for 0.4 atomic % and 1.6 atomic % of phosphorus compared with pure tin when a 10 N normal load is applied. The difference between the phosphorus doped tin samples and the pure tin sample is remarkable. The low and stable contact resistances for the tin-phosphorus samples were a result of the achieved gross welded contact spots. Additional experiments indicated that for pure tin at least three times higher contact load (30 N at the present test conditions) is needed to achieve a gross welded contact spot.

1. Contact terminal to be used for electrical purposes which contact terminal comprises a metallic substrate with good conductivity and coated with a metallic element, the coating being made of tin that is doped with at least one additive that improves electrical stability of the coating.

2. Contact terminal according to claim 1, wherein the amount of a phosphorus dope additive in the coating is between 0.05-2.0 atomic %.

3. Contact terminal according to claim 1 wherein the amount of phosphorus dope additive in the coating is between 0.1-0.2 atomic %.

4. Contact terminal according to claim 1, wherein the dopes additive is at least one of the elements copper, bismuth, silver, zinc, cobalt and antimony or a combination of the elements.

5. Contact terminal according to claim 1, wherein the dope additive is a combination of at least two selected from the group consisting of antimony, zinc and cobalt.

6. Contact terminal according to claim 1 wherein the substrate in the contact terminal is made of copper based alloy.

7. Contact terminal according to claim 1 wherein the substrate in the contact terminal is made of aluminum based alloy.
